(19) United States
(12) Patent Application Publication
(10) Pub. No.: US 2010/0126224 A1
(43) Pub. Date: May 27, 2010

(54) MOBILIZING STAGNANT MOLTEN MATERIAL

(76) Inventors: David Myron Lineman, Painted Post, NY (US); Robert Richard Thomas, Watkins Glen, NY (US)

Correspondence Address: CORNING INCORPORATED, SP-TI-3-1, CORNING, NY, 14831, US

(21) Appl. No.: 12/324,257

(22) Filed: Nov. 26, 2008

(51) Int. Cl. C03B 7/098

(52) U.S. Cl. 65/128; 65/324; 65/325

(57) ABSTRACT

A method of delivering molten material from a delivering pipe having an outlet end to a receiving vessel having an inlet end is provided. The method includes arranging the delivering pipe and the receiving vessel in such a way that a gap exists between the outlet end of the delivering pipe and the inlet end of the receiving vessel and the molten material can exit the outlet end of the delivering pipe and enter the inlet end of the receiving vessel without spilling over the inlet end of the receiving vessel. Molten material is delivered to the delivering pipe and allowed to flow from the delivering pipe into the receiving vessel. Molten material existing in the gap is heated to facilitate its flow,

### FIELD

The invention relates generally to methods and apparatus for forming a sheet of material. More specifically, the invention relates to a method and an apparatus for delivering molten material to a sheet forming apparatus.

### BACKGROUND

In the art of glass making, molten glass is frequently delivered from one vessel (such as a pipe) to another, before the glass is finally formed into the desired article and cooled to a lower temperature. The mass transfer of the molten glass can cause alteration of temperature and composition profile in the glass, which can be highly undesirable. One compositional change is the trapping of inclusions such as air bubbles and solid inclusions in the glass, which can lead to a lowered yield in the final glass product. For the manufacture of high-quality glass articles, especially optical glass elements such as the glass substrates of LCD displays, it is highly desirable that the glass bulk has a level of inclusions that is as low as possible.

Fusion process is used to make a sheet of material from molten material. The general fusion process is described in U.S. Pat. Nos. 3,338,696 and 3,682,609, both issued to Dockerty. Generally speaking, fusion process involves delivering molten material into a trough and overflowing the molten material down the sides of the trough in a controlled manner. The separate streams of material flowing down the sides of the trough merge at the root of the trough into a single stream of material that is drawn into a sheet of material. A key advantage of this process is that the surfaces of the sheet of material do not come in contact with the sides of the trough or other forming equipment and therefore are pristine. Another benefit of the process is that the sheet of material is very flat and has a uniform thickness.

Fusion process is the preferred method for making thin glass sheets for display applications. However, glass sheets for display applications are required to meet stringent conditions beyond having pristine surfaces, being very flat, and having uniform thickness. Defects such as gas and/or solid inclusions in the glass sheet are typically not desirable.

### SUMMARY

Thus, according to a first aspect of the present invention, a method of delivering molten material from a delivering pipe having an outlet end to a receiving vessel having an inlet end is provided. The method comprises (A) arranging the delivering pipe and the receiving vessel in such a way that a gap exists between the outlet end of the delivering pipe and the inlet end of the receiving vessel and the molten material can exit the outlet end of the delivering pipe and enter the inlet end of the receiving vessel without spilling over the inlet end of the receiving vessel; (B) delivering molten material to the delivering pipe and allowing the molten material to flow from the delivering pipe into the receiving vessel; and (C) heating the molten material existing in the gap to facilitate the flow thereof.

In certain embodiments of the first aspect of the present invention, the molten material comprises a molten glass.

In certain embodiments of the first aspect of the present invention, the delivering pipe is a downcomer pipe, and the receiving vessel is the inlet pipe of an isopipe in a fusion draw process.

In certain embodiments of the first aspect of the present invention, the downcomer pipe and the inlet pipe of the isopipe are both circular and essentially concentric.

In certain embodiments of the first aspect of the present invention, in step (A), the outlet end of the delivering pipe is submerged in the molten material.

In certain embodiments of the first aspect of the present invention, in step (A), the outlet end of the delivering pipe is not submerged in the molten material.

In certain embodiments of the first aspect of the present invention, step (C) comprises raising the temperature of the molten material existing in the gap by approximately 20° C. or higher.

In certain embodiments of the first aspect of the present invention, the molten material is electrically conductive, and step (C) comprises passing an electrical current through the molten material existing in the gap.

In certain embodiments of the first aspect of the present invention, the electrical current passing through the molten material essentially does not cause an electrolysis of the molten material.

In certain embodiments of the first aspect of the present invention, the electrical current is an alternating current.

In certain embodiments of the first aspect of the present invention, the outlet end of the delivering pipe and the inlet end of the receiving vessel are electrically conductive, and step (C) comprises applying an electric voltage between the outlet end of the delivering pipe and the inlet end of the receiving vessel.

In certain embodiments of the first aspect of the present invention, the voltage applied between the outlet end of the delivering pipe and the inlet end of the receiving vessel is an alternating voltage.

In certain embodiments of the first aspect of the present invention, the outlet end of the delivering pipe and the inlet end of the receiving vessel are essentially concentric.

In certain embodiments of the first aspect of the present invention, the gap between the outlet end of the delivering pipe and the inlet end of the receiving vessel is essentially annular.

In certain embodiments of the first aspect of the present invention, the outlet end of the delivering pipe and the inlet end of the receiving vessel both comprise platinum or a platinum alloy.

In certain embodiments of the first aspect of the present invention, step (C) is carried out constantly during step (B).

In certain embodiments of the first aspect of the present invention, step (C) is carried out intermittently during step (B).

In certain embodiments of the first aspect of the present invention, step (C) is carried out immediately after the molten material starts to fill the gap between the outlet end of the delivering pipe and the inlet end of the receiving vessel.

In certain embodiments of the first aspect of the present invention, step (C) is carried out for a sufficient period of time such that the level of inclusions trapped in the molten material existing in the gap is essentially the same as in the molten glass immediately exiting the outlet end of the delivering pipe.

In certain embodiments of the first aspect of the present invention, step (C) is carried out after the molten material submerges the outlet end of the delivering pipe.

According to a second aspect of the present invention, an apparatus for delivering a molten material is provided. The apparatus comprises (i) a delivering pipe having an outlet end; (ii) a receiving vessel having an inlet end capable of receiving the molten material exiting the outlet end of the delivering pipe and capable of being arranged relative to the delivering pipe such that a gap exists between the outlet end of the delivering pipe and the inlet end of the receiving vessel; and (iii) a device capable of differentially heating the molten material in the gap, if the molten material fills the gap between the outlet end of the delivering pipe and the inlet end of the receiving vessel.

In certain embodiments of the second aspect of the present invention, the outlet end of the delivering pipe and the inlet end of the receiving vessel comprise an electrically conductive material.

In certain embodiments of the second aspect of the present invention, the device capable of differential heating comprises an AC power supply adapted for supplying an AC voltage to the molten material that fills the gap between the outlet end of the delivering pipe and the inlet end of the receiving vessel.

In certain embodiments of the first aspect of the present invention, the outlet end of the delivering pipe extends into the inlet end of the receiving vessel.

One or more embodiments of the present invention has one or more of the following advantages. First, by heating molten material in a stagnant area between the delivering pipe and the receiving vessel, the viscosity of the molten material in the stagnant area is lowered. As a result, the molten material in the stagnant area is mobilized and can be flushed away by the molten material injected into the receiving vessel by the delivering pipe more readily This enables a shorter period during which defective sheet of material is produced due to defects in this stagnant area. Second, by passing an electrical current through the molten material, the molten material can be heated substantially uniformly in a controlled manner. Third, by activating the heating after a defect appears in the stagnant area, the heating can be turned on to subsequently quickly flush away the defective glass.

Other features and advantages of the invention will be apparent from the following description and the appended claims.

### BRIEF DESCRIPTION OF DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain views of the figures may be shown exaggerated in scale or in schematic in the interest of clarity and conciseness.

FIG. 1 is a schematic of an exemplary apparatus for making a sheet of material.

FIG. 2 is an enlargement of a portion of the apparatus of FIG. 1 and shows a receiving vessel positioned to receive molten material from a delivering pipe.

FIG. 3 is a cross-sectional view taken along line 3-3 of FIG. 2.

FIG. 4 schematically illustrates one stage of a method for mobilizing stagnant material between the delivering pipe and receiving vessel of FIG. 2.

FIG. 5 schematically illustrates another stage of a method for mobilizing stagnant material between the delivering pipe and receiving vessel of FIG. 2.

### DETAILED DESCRIPTION

The present invention can be applied to the delivery of any molten materials, including, but not limited to, glass melt (or molten glass). Advantageously, the present invention is applied to the delivery of a molten material that is electrically conductive, and can be heated therefore by passing an electrical current through it.

In a particularly advantageous embodiment of the present invention, the present invention is applied to the delivery of molten glass (or glass melt). The present invention is particularly advantageous for delivering molten glass that is electrically conductive when being processed. Such glass materials would include, but are not limited to, boroaluminosilicate glasses; soda lime glasses, other oxide glasses comprising alkali metal oxides and/or alkaline earth oxides in the compositions thereof, and the like.

The present invention involves the delivery of molten materials. Thus, in the case of molten glass, the present invention method of delivery can be used for any and all glass making technologies, including the float process, pressing, rolling, slot draw, fusion draw, and the like, as long as the glass is delivered from a delivering pipe to a receiving vessel before forming into the final, defined shape. The present invention will be described below in detail in the context of a few embodiments in the fusion draw technology. However, one having ordinary skill in the art, after learning the teachings of the present application, will understand that the present invention can be adapted for other glass making technologies, mutatis mutandis.

A few embodiments of the invention will be described below in detail with reference to the accompanying drawings. In describing the few embodiments, numerous specific details may be set forth in order to provide a thorough understanding of the invention. However, it will be apparent to one skilled in the art that the invention may be practiced without some or all of these specific details. In other instances, well-known features may not be described in detail so as not to unnecessarily obscure the invention. In addition, like or identical reference numerals may be used to identify common or similar elements.

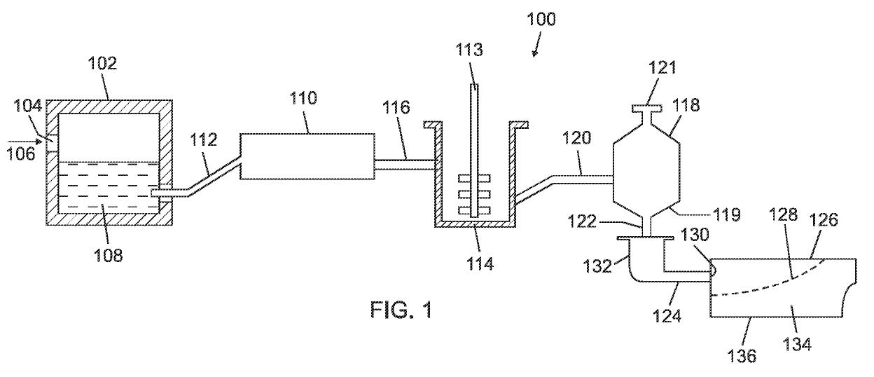

FIG. 1 is a schematic of an apparatus 100 for forming a sheet of material, such as a sheet of glass-based material. Apparatus 100 may be a system of apparatus, as will be described below. In one example, apparatus 100 includes a melting vessel 102 having an opening 104 for receiving a batch 106 of raw materials. Heat is generated within or supplied to the melting vessel 102 to melt the batch 106 into molten material 108. In one non-limiting example, the molten material 106 is molten glass. In other non-limiting examples, the molten material 108 may be molten glass-ceramic or other type of molten glass-based material. In general, the molten material can be any molten material that is electrically conductive. In the remaining description, molten glass will be used as an example of molten material 108. Apparatus 100 may include a fining vessel 110, which may receive molten glass 108 from the melting vessel 102 via a conduit 112. Inside the fining vessel 110, the molten glass 108 is processed to remove gas inclusions, which may have been introduced into the molten glass during decomposition of the batch 106 in the melting vessel 102. Removal of gas inclusions may be by chemical fining or reduced pressure/vacuum fining, as is known in the art.

Apparatus 100 may include a stirring vessel 114, which may receive molten glass 108 from the fining vessel 110 via a conduit 116. Inside the stirring vessel 114 the molten glass 108 is mixed to improve its homogeneity. Apparatus 100 includes a delivery vessel 118, which may receive molten glass 108 from the stirring vessel 114 via a conduit 120. A stirrer 113 in the stirring vessel 114 may assist in filtering out solid inclusions from the molten glass 108 delivered to the conduit 120. The delivery vessel 118 may be open at the top 121, thereby exposing the molten glass 108 therein to ambient atmosphere. A delivering pipe 122 is connected to or mounted below the delivery vessel 118. In this position, molten glass from the delivery vessel 118 can flow into the delivering pipe 122. In a non-limiting example, the delivering pipe 122 is a downcomer pipe. The delivery vessel 118 may include a conical portion or bowl 119, which allows the molten glass 108 to swirl while flowing into the downcomer pipe 122, thereby helping the molten glass 108 to maintain its homogeneity.

Apparatus 100 includes a forming vessel 126. In a non-limiting example, the forming vessel 126 is an isopipe and may be a component of a fusion draw machine. In one non-limiting example, the forming vessel 126 includes a trough 128 having an opening, indicated generally at 130, for receiving the molten glass 108 into the trough 128. An inlet pipe 124 is connected to the opening 130 and can be used to deliver molten glass 108 to the opening 130. The inlet pipe 124 includes a receiving vessel 132, which is adjacent to the delivering pipe 122 and arranged to receive molten glass 108 from the delivering pipe 122. In one non-limiting example, the receiving vessel 132 is a riser pipe. Molten glass 108 received in the trough 128 of the forming vessel 126 overflows and runs down the sides 134 (only one side is visible in the view shown in FIG. 1) of the forming vessel 126, eventually merging into a single stream of molten glass at the root 136 of the forming vessel 126. The single stream of molten glass 108 is drawn into a glass sheet.

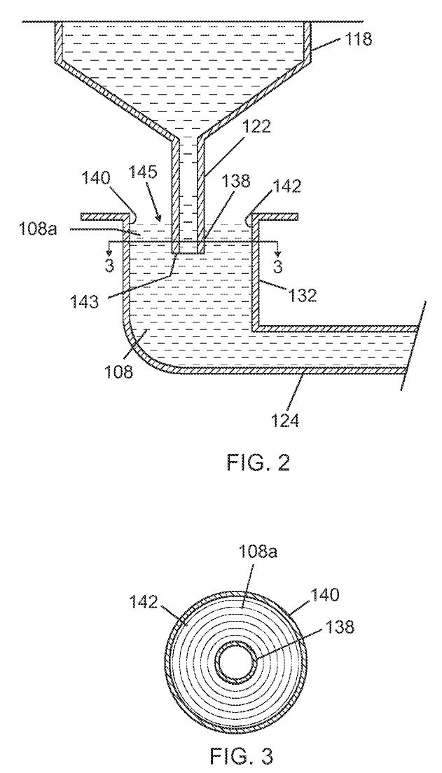

FIG. 2 is an enlargement of the interface between the delivering pipe 122 and the receiving vessel 132. As illustrated, the delivering pipe 122 is aligned with the receiving vessel 132. The term “aligned,” as used herein, means that the delivering pipe 122 and receiving vessel 132 are arranged in such a way that molten material can exit the delivering pipe 122 and enter the receiving vessel 132, generally without spilling over and running down the sides of the receiving vessel 132. In one non-limiting example, such alignment includes receiving an outlet end 138 of the delivering pipe 122 in an inlet end 140 of the receiving vessel 132. This requires that the outer diameter of the outlet end 138 is smaller than the inner diameter of the inlet end 140. The outlet end 138 may or may not be concentric with the inlet end 140 when received in the inlet end 140. In one non-limiting example, the cross-sections of the delivering pipe 122 and the receiving vessel 132 are circular. In the arrangement shown in FIG. 2, a gap 142 is defined between the outlet end 138 of the delivering pipe 122 and the inlet end 140 of the receiving vessel 132. A cross-sectional view of the gap 142 is shown schematically in FIG. 3. The gap 142 may be annular in shape. Returning to FIG. 2, the gap 142 is unsealed and in communication with the interior of the receiving vessel 132. As a result, the molten glass 108 received in the receiving vessel 132 is exposed to ambient atmosphere through the gap 142.

During the manufacture of the sheet glass, the molten glass 108 may entrain blisters due to various causes. Upstream process steps, such as glass melting, fining, and homogenization, can intrinsically lead to a certain amount of gas and/or solid inclusions in the glass delivered from the delivering pipe 122 to the receiving vessel 132. Furthermore, the molten glass 108 in the receiving vessel 132, due to contact with refractory materials and ambient atmosphere, may be contaminated by blister-causing particles or solid inclusions.

While molten glass 108 flows from the delivering pipe 122 into the receiving vessel 132, some of the molten glass 108 may enter into the gap 142 and remain in the gap 142 until circulated back into the main glass stream 108 in the receiving vessel 132. As the molten glass 108a circulates back into the main glass stream 108, any defects in the molten glass 108a will also circulate back into the main glass stream 108. If the molten glass 108a in the gap 142 is stagnant, defects such as described above will bleed out of the gap 142 at a slow rate, e.g., over a period of 7 to 10 days. During this extended bleeding period, the glass sheet produced will have defects, leading to production losses. High concentration of defects in the stagnant glass can translate to large quantity of glass products manufactured with unacceptably high level of defects. Therefore, it is highly desirable that stagnant molten glass in the gap 142 is mobilized so that amount of such defective glass product is minimized.

Referring to FIG. 2 for illustrative purposes, a conventional procedure for mobilizing stagnant glass in the gap 142 between the delivering pipe 122 and the receiving vessel 132 includes raising the delivering pipe 122 relative to the receiving vessel 132 or lowering the receiving vessel 132 relative to the delivering pipe 122 such that the exit end 143 of the delivering pipe 122 is above the glass line 145 in the receiving vessel 132. This act of raising the delivering pipe 122 or lowering the receiving vessel 132 results in mobilizing of the molten glass 108a in the gap 142, leading to faster circulation of the molten glass 108a in the gap 142 back into the main glass stream 108 in the receiving vessel 132. After the molten glass in the gap 142 has been circulated back into the main glass stream 108, the exit end 143 of the delivering pipe 122 is again immersed in the molten glass 108 in the receiving vessel 132.

However, there are risks associated with the conventional procedure of mobilizing stagnant glass described above. For example, in a glass sheet forming process involving Zirconia-rich glass, it was found that Zirconia-rich glass had entered into the gap 142 and become stagnant. The long residence time and temperature of the glass allowed the Zirconia-rich glass to devitrify, forming secondary Zircon inclusions that bled slowly from the gap 142 into the main glass stream 108. The conventional procedure of mobilizing stagnant glass out of the gap 142 described above was used. However, shortly after lowering the receiving vessel 132 so that the glass level 145 in the receiving vessel 132 was below the exit end 143 of the delivering pipe 122, blisters in the formed glass sheet escalated to a level at which the production line sustained 100% loss. When the receiving vessel 132 was restored to its normal level a few days later, the blisters followed a typical concentration decay curve over the next 7 days until the level of blisters was normal.

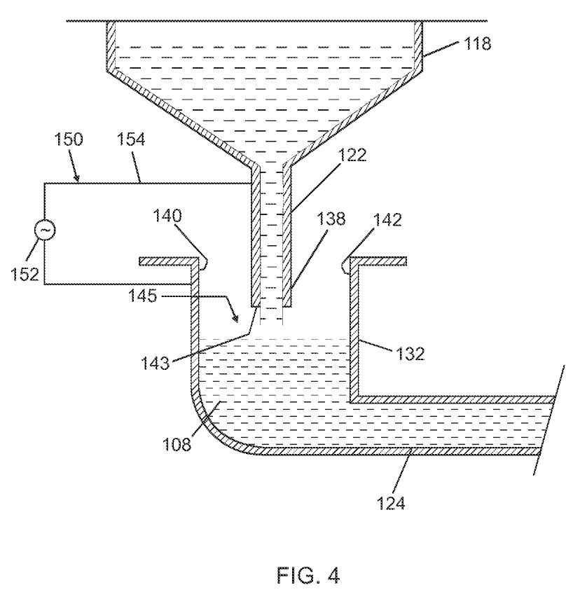

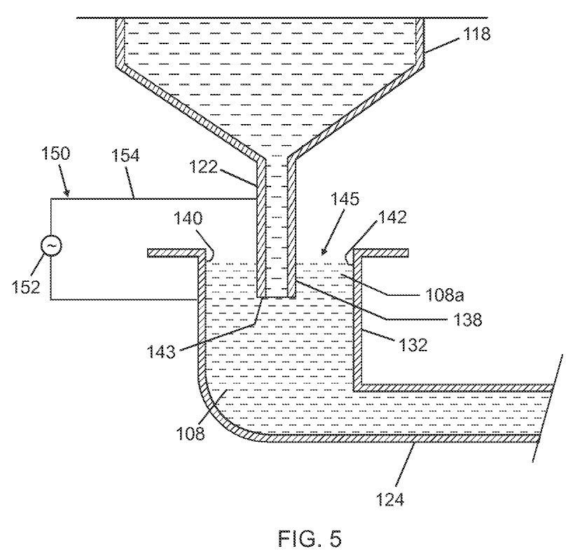

A method proposed herein for mobilizing stagnant molten glass in the gap 142 includes active heating of the molten glass 108a in the gap 142. As illustrated in FIGS. 4 and 5, a heating circuit 150 may be connected across the gap 142 and operated to supply heat to the molten glass 108a in the gap 142. The heating circuit 150 may be operated to supply heat to the gap 142 while the exit end 143 of the delivering pipe 122 is above the glass line 145 in the receiving vessel 132, as shown in FIG. 4, or when the exit end 143 of the delivering pipe 122 is below the glass line 145 in the receiving vessel 132, as shown in FIG. 5. When molten glass 108a is present in the gap 142, the heat supplied to the gap 142 mobilizes the molten glass 108a in the gap 142, leading to the molten glass 108a flowing from the gap 142 into the main glass stream 108 more quickly than if heat had not been applied to the gap 142.

While molten material 108 flows from the delivering pipe 122 to the receiving vessel 132, heat may be supplied to the gap 142 intermittently, e.g., whenever it is discovered that there is defective stagnant glass (or other molten material) in the gap 142, or continuously. In one non-limiting example, heat is supplied to the gap 142 as soon as molten glass 108 starts flowing from the delivering pipe 122 into the receiving vessel 132 and selectively thereafter. In one non-limiting example, heat is supplied to the gap 142 as soon as molten glass 108 starts filling the gap 142. In one non-limiting example, heat is supplied to the gap 142 until the molten glass in the gap 142 has a defect level, e.g., an inclusion level, that is essentially the same as the bulk molten glass 108 in the receiving vessel 132. In one non-limiting example, heat is supplied to the gap 142 after the exit end 143 of the delivering pipe 122 is submerged in the molten material 108 in the receiving vessel 132. In one non-limiting example, the heat applied to the gap 142 is substantially confined to the gap 142 so that the overall temperature of the molten glass 108 in the receiving vessel 132 is not significantly raised. In one non-limiting example, heat is distributed uniformly in the gap 142.

The heating circuit 150 may be implemented in a variety of ways. In one example, the heating circuit 150 includes an alternating-current (AC) power supply 152. AC power has the advantage that at a large current density the glass melt would not be subjected to electrolysis, which can generate bubbles and other unwanted blisters in the glass. On the other hand, a direct current (DC) can easily electrolyze a glass melt, reduce or oxidize certain components of the glass, causing blisters and/or inclusions, e.g., O₂ inclusion, in the glass. A connection 154 is made between the AC power supply 152 and the delivering pipe 122. If it is difficult or inconvenient to make the connection 154 directly to the delivering pipe 122, the connection 154 may he made between the AC power supply 152 and the delivery vessel 118 instead. Where the delivering pipe 122 is in contact with the delivery vessel 118, a connection made to the delivery vessel 118 would be like a connection made to the delivering pipe 122. A connection 158 is also made between the receiving vessel 132 and the AC power supply 152. The connection 158 can be a grounding wire. In one example, the delivering pipe 122 and receiving vessel 132 are made of a material that allows them to conduct electrical current. In another example, at least the outlet end 138 of the delivering pipe 122 and the inlet end 140 of the receiving vessel 132 are made of a material that is electrically conductive. In one non-limiting example, at least the outlet end 138 of the delivering pipe 122 and the inlet end 140 of the receiving vessel 132 are made of a platinum alloy. Typically, the material of the delivering pipe 122 and receiving vessel 132 is one that will not react with the molten material 108.

When molten material is first delivered from the delivering pipe 122 into an empty receiving vessel 132, the glass line in the receiving vessel 132 is practically located at the bottom of the receiving vessel 132 and the empty space between the exit end 143 of the delivering pipe 122 and the glass level in the receiving vessel 132 is relatively large. Once a continuous stream of molten glass 108 is established between the exit end of the delivering pipe 122 and the bottom of the receiving vessel 132, the voltage applied between the delivering pipe 122 and the receiving vessel 132 will form a circuit loop, allowing the molten glass 108 to be heated by the flowing electrical current. As the glass level 145 in the receiving vessel 132 rises, the empty space between the exit end 143 of the delivering pipe 122 and the glass level 145 in the receiving vessel 132 will gradually decrease, as illustrated in FIG. 4. Eventually, the exit end 143 of the delivering pipe 122 will be submerged in the molten glass 108 in the receiving vessel 132, as shown in FIG. 5, allowing the molten glass to enter the gap 142. Electrical current delivered by the heating circuit 150 will pass through all the molten glass 108a in the gap 142.

Referring to FIG. 5, as molten glass flows from the delivering pipe 122 to the receiving vessel 132, additional fresh molten glass would be injected from the exit end 143 of the delivering pipe 122 to below the glass line 145 in the receiving vessel 132. Without additional active heating of the molten glass 108a in the gap 142, the molten glass 108a in the gap 142 will become relatively stagnant, i.e., less likely to be flushed away by the fresh glass stream introduced into the receiving vessel 132. By passing electrical current through the molten glass 108a in the gap 142 using, for example, the heating circuit 150, the molten glass 108a in the gap 142 can be heated to a high temperature and lower viscosity, which would make it much easier for the molten glass 108a to be flushed away by the molten glass flow underneath.

In general, electrical current will flow from the AC power supply 152 to the delivering pipe 122, down the delivering pipe 122, through the molten glass 108a in the annular gap 142, and out through the receiving vessel 132. In one example, the heating circuit 150 fires AC current primarily in the gap 142, thereby restricting the supplied heat substantially to the gap 142. Because of the relatively high local resistance of the glass in the gap 142, a majority of the power will be dissipated in the gap 142. Because the mass of the molten glass 108a in the gap 142 is small, the mass can be heated very quickly in a short time. The amount of voltage necessary to heat the molten glass in the gap 142 will depend on the electrical resistance of the molten glass in the gap 142, which in turn would depend on the immersion depth of the delivering pipe 122 in the molten glass 108 in the receiving vessel 132. In one example, supplying heat to the gap 142 includes raising the temperature of the molten glass in the gap 142 by approximately 20° C. or higher, in certain embodiments at least 25° C., in certain embodiments at least 30° C., in certain embodiments at least 40° C., in certain embodiments at least 50° C.

Other methods of supplying heat to the gap 142, or differentially heating the molten glass 108a in the gap 142, may be used. For example, a resistive filament loop made of a suitable material that will not react with the molten glass 108 may be disposed in the gap 142 to heat the molten glass 108a. The filament may be connected to a suitable power source to deliver heat to the gap 142. Other forms of heating the molten glass 108a in the gap 142, such as inductive heating, may also be used.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of delivering molten material from a delivering pipe having an outlet end to a receiving vessel having an inlet end, comprising:
(A) arranging the delivering pipe and the receiving vessel in such a way that a gap exists between the outlet end of the delivering pipe and the inlet end of the receiving vessel and the molten material can exit the outlet end of the delivering pipe and enter the inlet end of the receiving vessel without spilling over the inlet end of the receiving vessel;
(B) delivering molten material to the delivering pipe and allowing the molten material to flow from the delivering pipe into the receiving vessel; and
(C) heating the molten material existing in the gap to facilitate the flow thereof.

2. The method of claim 1, wherein the molten material comprises a molten glass.

3. The method of claim 2, wherein the delivering pipe is a downcomer pipe, and the receiving vessel is the inlet pipe of an isopipe in a fusion draw process.

4. The method of claim 3, wherein the downcomer pipe and the inlet pipe of the isopipe are both circular and essentially concentric.

5. The method of claim 1, wherein in step (A), the outlet end of the delivering pipe is submerged in the molten material.

6. The method of claim 1, wherein in step (A), the outlet end of the delivering pipe is not submerged in the molten material.

7. The method of claim 1, wherein step (C) comprises raising the temperature of the molten material existing in the gap by approximately 20° C. or higher.

8. The method of claim 1, wherein the molten material is electrically conductive, and step (C) comprises passing an electrical current through the molten material existing in the gap.

9. The method of claim 8, wherein the electrical current passing through the molten material essentially does not cause an electrolysis of the molten material.

10. The method of claim 8, wherein the electrical current is an alternating current.

11. The method of claim 8, wherein the outlet end of the delivering pipe and the inlet end of the receiving vessel are electrically conductive, and step (C) comprises applying an electric voltage between the outlet end of the delivering pipe and the inlet end of the receiving vessel.

12. The method of claim 11, wherein the voltage applied between the outlet end of the delivering pipe and the inlet end of the receiving vessel is an alternating voltage.

13. The method of claim 1, wherein the outlet end of the delivering pipe and the inlet end of the receiving vessel are essentially concentric.

14. The method of claim 1, wherein the gap between the outlet end of the delivering pipe and the inlet end of the receiving vessel is essentially annular.

15. The method of claim 1, wherein the outlet end of the delivering pipe and the inlet end of the receiving vessel both comprise a platinum alloy.

16. The method of claim 1, wherein step (C) is carried out constantly during step (B).

17. The method of claim 1, wherein step (C) is carried out intermittently during step (B).

18. The method of claim 1, wherein step (C) is carried out immediately after the molten material starts to fill the gap between the outlet end of the delivering pipe and the inlet end of the receiving vessel.

19. The method of claim 18, wherein step (C) is carried out for a sufficient period of time such that the level of inclusions trapped in the molten material existing in the gap is essentially the same as in the molten glass immediately exiting the outlet end of the delivering pipe.

20. The method of claim 1, wherein step (C) is carried out after the molten material submerges the outlet end of the delivering pipe.

21. An apparatus for delivering a molten material, comprising:
(i) a delivering pipe having an outlet end;
(ii) a receiving vessel having an inlet end capable of receiving the molten material exiting the outlet end of the delivering pipe and capable of being arranged relative to the delivering pipe such that a gap exists between the outlet end of the delivering pipe and the inlet end of the receiving vessel; and
(iii) a device capable of differentially heating the molten material in the gap, if the molten material fills the gap between the outlet end of the delivering pipe and the inlet end of the receiving vessel.

22. An apparatus of claim 21, wherein the outlet end of the delivering pipe and the inlet end of the receiving vessel comprise an electrically conductive material.

23. An apparatus of claim 21, wherein the device (iii) comprises an AC power supply adapted for supplying an AC voltage to the molten material that fills the gap between the outlet end of the delivering pipe and the inlet end of the receiving vessel.

24. An apparatus of claim 21, wherein the outlet end of the delivering pipe extends into the inlet end of the receiving vessel.
